(19) United States
(12) Patent Application Publication
(10) Pub. No.: US 2006/0018820 A1
(43) Pub. Date: Jan. 26, 2006

(54) Magnetic stimulated nucleation of single crystal diamonds

(76) Inventor: Reginald Bernard Little, Tallahassee, FL (US)

Correspondence Address: Dr. Reginald Bernard Little, 308 Great Lakes St, Tallahassee, FL, 32305, US

(21) Appl. No.: 10/894,500

(22) Filed: Jul. 20, 2004

(51) Int. Cl. C01B 31/02

(52) U.S. Cl. 423/445 B

(57) ABSTRACT

An apparatus for the crystalline, mass and selective syntheses of diamonds and carbon nanotubes (CNT) includes a chamber having at least one source of carbon and possibly a source of metal on a substrate surface (atoms, clusters and/or nanoparticles); at least one resistance heating element; at least one exciting and heating laser at least one IR source; at least one magnetic field generator; and at least one pressure device. In operation, carbon and metal atoms are supplied to the heated reaction chamber for contacting with substrate supported catalyst, a heating laser beam and an IR source, and then for contacting with an intense magnetic field sufficient amount of interaction between the excited carbon and metal atoms IR, laser, thermal energy and the magnetic field so as to excite, create, catalyze and stabilize electronic spin transitions and high electronic spin states of the excited carbon and metal atoms (for the production of high spin triplett, quartet and pentet carbon atoms) under chemical vapor deposition conditions, leading to the activated and more efficient rehybridization of these high spin carbon atoms for the massive chemical condensation of diamonds and/or CNTs. The specific photons of the laser may stimulate the nucleation of specific helical and diametric CNTs. An even greater massive chemical condensation is driven by selective, periodic and rapidly heating the metal catalyst via the IR-heating source for more efficient localization of energy for electronic, chemical and transport dynamics of high spin carbon atoms through the catalyst for lower ambient temperature selective condensation of CNT. The external magnetic field also provides conditions for creating, stabilizing, reacting and confining these high spin carbon and metal atoms. The continual supply, rehybridization and population inversion of carbon atoms overtime provides conditions conducive the massive and selective diamond and/or CNT productions. By operating the device to physically catalyze and stabilize electronic fixation of high spin states of carbon atoms by intense static arid/or dynamic magnetic fields, the chemical contamination is eliminated or may be modulated for controlled doping during the formation of diamonds and/or CNT, respectively. By operating the device to electronically fix carbon using the catalyst and magnetic fields, the electronic rehybridization rate is enhanced over the rates of currently used older arts of chemical catalytic fixation due to the reinforcing external magnetic field under CVD conditions relative to the intrinsic field of the catalyst and spin interactions with carbon atoms in the absence of the external magnetic field. The external field stabilizes high spin states of carbon and metal atoms, and enhances the intrinsic spin effects of the transition metal for chemical catalytic fixation. Moreover, an intense static external magnetic field stabilizes high spin carbon intermediates leading to stimulated diamond formation. On the other hand an intense dynamic external magnetic field intensified intrinsic spin density waves of the catalyst for enhanced CNT formation. This monumental discovery of magnetically activated rehybridization and stabilization of excited carbon contributes a watershed in the industrial massive production of diamonds and CNT when this magnetic discovery is coupled to new heating methods using IR photons. Furthermore, the stronger magnetic stabilization in this art relative to the weaker inherent fields in the catalyst of the older chemical catalytic art allow lower temperature generation of diamond and CNT. This new art provides diamond-CNT composite materials for novel diamond-CNT interfaces, new doping during the synthesis of diamond. Also in this new art, the magnetic densification of high spin carbon atoms allows more low pressure synthesis of diamond relative to older art. By switching the magnetic field on and off, this new art allows the selection of diamond or carbon nanotube growth.

### FIELD OF THE INVENTION

The present invention involves a method and apparatus for the massive and selective formations of diamond and CNT. The present invention has particular applicability in selectively producing such carbonaceous articles in high yield, purity and throughput. The invention provides a means of using external magnetic fields of intense static and dynamic durations, spatial and temporal natures to enhance the formation of these valuable carbonaceous products: diamond and CNT. The invention also makes use of laser technology in an innovative way by for the first time using the laser and IR photons to rapidly heat the metal catalysts for more efficient catalyzed activation for carbon fixation to important high spin (hybrid) carbon intermediates for the stimulated, selective chemical condensation of these intermediates into massive amounts of diamonds and/or CNTs. The invention further exploits laser technology to drive plasmons and phonons in catalyst for the controlled carbon-metal interactions for facile carbon absorption, diffusion, rehybridization, and condensation within and on the catalysts. The new art's use of laser and magnetic phenomena to generate high density of high spin carbon atoms for magnetic densification leads to lower pressure and temperature fabrication of diamonds in intense static magnetic fields. On the other hand, the new art uses laser and dynamic, intense magnetic fields to enhance spin density phenomena for facilitating rehybridization, transport and chemical condensation of intermediary spin SP² carbon for CNT fabrication.

### BACKGROUND

Carbonaceous materials possess a wide variety of applications due to their unique electronic structure and chemical bonding. Current interests in these materials reflect their unusual strength and toughness; their electric transport (CNT), their large thermal transport (CNT, diamond), their novel optical properties, their chemical stability and their storage capacity (CNT). It has been shown that these carbon-based materials provide high strength, low weight, stability, flexibility, good heat and electric conductivity and large surface area for a variety of applications. Individually these materials are superior in properties. Collectively even more extraordinary properties are envisioned.

The industrial potential of these materials encompasses many products ranging from nanoelectronic to composite bulky strong structures to ultra-fast optical switching devices to hydrogen fuel cells. Collectively, diamond-CNT supercomposite devices pose many new applications.

The best know techniques for fabricating CNT, fullerenes and diamonds involve the use of laser, arc and catalytic-thermal CVD systems. Collectively, no other reports of single pot preparation suitable for indusry.

Even with these advancements of the older art more development is in order for more massive production of CNT and diamond to spur the growing carbon-based materials industry. An even greater capability would be the simultaneous or sequential preparation of diamond and CNT via an in-situ single pot technique.

This invention makes use of these older systems and other systems as sources of carbon and metal atoms for magnetically driven activated and optically stimulated chemical condensation of CNT and diamond.

### BRIEF SUMMARY OF THE INVENTION

One of the improvements of the present invention is an apparatus for massively producing CNT and diamond in higher yield, purity, selectivity and efficiency.

Another improvement of the invention is an apparatus for massively producing CNT and diamond with less effort, expense and cost by making use of readily available electric power. The new art exploits magnetic fields and photon effects for eliminating the high temperature and pressure conditions of older art with the needy discovered advantage of producing diamond and CNT with less effort.

Another improvement of the present invention is its applicability and industry of both diamonds and CNTs, create new composite industry with a single pot synthesis. This new art provides magnetic fields and laser photons for use with current CVD techniques with the enhancement of the ability of these techniques for generating and selecting CNT and diamond. The enhancement is a result of the stabilization of energy and uniformly coherent energy provided by the magnetic field and laser photons in comparison to heat and phonons in older art.

Another improvement of the present invention is its inherent capability for in-situ selectivity of CNT and diamond products as they form. Such in-situ selectivity is lacking by older art. Most existing techniques (although limited) cannot select between CNT and diamonds. The high-energy (beyond U-V) conditions and instability of carbon atoms complicates the formations. The rich bonding and vibration characters of graphite, CNT and diamond complicate the carbon chemistry leading to various products. In particular magnetic stabilization for control of logic, reasoning, action, manipulation of process variables and feed-back control are feasible due to advantages provided by this new invention.

Additional improvements and other features of the present invention will be put forth in the description which follows and in part will be apparent to those having ordinary skill in the art upon examination of the following or may be learned from the practice of the present invention. The progress and improvements of the present invention may be realized and ascertained as outlined in the appended claims.

On basis of the present invention, the foregoing and other advantages are achieved in part by a new apparatus for producing CNTs and diamonds. The apparatus consists of a reaction chamber having at least one heating element, at least one port for introducing carbon and metal precursors and background gases, at least one port for exhaust gases. The heating element can be any element useful for heating the content of the reaction chamber and the ports can be a gas inlet and outlet. Metal catalyst (atoms, cluster, nanoparticles and/or macroparticles) may be disposed in the reaction chamber. At least one laser radiation source may be disposed to the reaction chamber for rapidly exciting and heating carbon and metal atoms. At least one magnetic field generator may be affecting the content of the reaction chamber for magnetic densification. At least one device for affecting the internal pressure of the reaction chamber is involved. At least one laser IR heating source is arranged within the reaction chamber for selectively heating the metal catalysts. The thermal energy, catalyst, laser fields, magnetic fields, and IR heating facilitate the catalytic conversion of carbon precursors to diamond and CNT.

In accordance with the current inventive apparatus, a IR heater is positioned near the reaction chamber that is capable of selectively interacting and heating the catalyst on the Si substrate. The IR advantageously allows the rapid selective input of heat to the catalysts for more efficient driving carbon absorption, diffusion, rehybridization and condensation.

In accordance with the current inventive apparatus, a laser for heating the catalyst is focused on the Si substrate and embedded catalyst. The laser provides intense energy for driving carbon diffusion, rehybridization and conensation.

In accordance with the current inventive apparatus, a magnetic generator is positioned about the reaction chamber that is capable of generating sufficient magnetic fields for confining the high density of high spin carbon atoms produced by the catalyst and laser-IR energy. The magnetic field may be of sufficient intensity to create, stabilize and rehybridize important high spin hybridized electronic states of carbon atoms. The magnetic densification facilitates the proximity for collisional condensation of diamond and CNT.

Embodiments of the present invention include an apparatus comprising a reactive chamber, an IR, a catalyst source, a carbon precursor source (CVD), a heating device, a pressure device, a heating laser, a magnetic field generator. The IR beam from the source is energetically tuned and focused so as to be contacted with the metal catalyst atoms to selectively heat the catalyst raising its temperature relative to the surrounding. The magnetic field is tuned dynamically or statically of sufficient intensity to affect the electronic states of carbon and metal atoms.

The nature of the catalyst disposed to the reaction chamber comprises any transition metal and/or transition metal compound. Although allowed the catalyst may not be necessary due to new influence of the neutrons for carbon rehybridization and fixation.

Another aspect of the current invention is a new method of manufacturing diamond and CNT. The method involves contacting a carbon containing precursor and possibly a metal containing precursor with an IR source for selectively heating the metal; applying magnetic fields to form, control and concentrate the reaction media and facilitating rehybridization; applying laser oscillating field to heat the generated high spin carbon atoms about useful intermediary excited states; applying laser to stimulate the vibration condensations of diamonds or stimulate specific helices and diameters of CNTs and applying heating device to control the chamber temperature. All of these applications hereby listed enhance the selective formation of CNT and diamond for the massive production of large diamond and bulk amounts of CNT.

The inventive method advantageously selectively produces CNT and diamond without the need for further purification thereby minimizing the loss due to purification processes. By IR and magnetic interactions, the product is not chemically subject to adulteration during the fabrication, the yield and selectivity are also improved with lower energy input reducing the soot generation and cost. This magnetic and IR enhanced formation of diamond may allow the intentional doping of diamond.

Embodiments of the current invention comprise forming a carbon article by contacting carbon atoms and metal atoms with a magnetic field at elevated temperature (e.g. from 100° C. to 1000° C.) and pressure (10⁻⁵ -10⁶ atm) with external laser and IR irradiation for enhanced catalytic rehybridization and densification that is aided by applying magnetic fields of at least 1 tesla.

Another aspect of the present invention is a method of using magnetic field for the selective production of diamonds and CNTs, the method facilitates the insitu single pot synthesis of diamond and/or CNT or diamond-CNT composites.

Other aspects of the present invention are carbonaceous articles, e.g. diamond structures, CNT and fullerenes. Embodiments include where the articles comprise over 95% carbon with significant reduction of impurities.

Additional improvements of the present invention will become readily apparent to those skilled in this art from the following detailed description wherein embodiments of the present invention are described simply by way of illustrated of the best mode contemplated for carrying out the present invention. As will be realize, the present invention is capable of other and different embodiments, its several details are capable of modifications in various respects, all without departing from the present invention. Accordingly, the drawing and descriptions are to be regarded as illustrative in nature and not restrictive.

### DESCRIPTION OF THE INVENTION

The current invention focuses and resolves various issues associated with the production rate, yield and selectivity of CNTs and diamonds by providing a novel efficient, selective and massive synthetic technique by using intense static and dynamics magnetic fields with IR and laser heating to enhance the dynamics of the catalytic carbon atomization, hybridization, diffusion and condensation during diamond and CNT formations. The present invention contemplates a novel technique to selectively, efficiently and rapidly enhance the electronic fixation of carbon atoms (and possibly metal atoms) during the formation of these carbonaceous article by various the CVD technique. The invention is simple in its design. It is however very effective in its use, overcoming the difficulties associated with electronic rehybridization of carbon atoms, the implications from the instability of these intermediate carbon species and the dynamics of electronic relaxation, regeneration and chemical combination associated with these states. The consequences of better product rate and selectivity with little required muscle outweigh the high electric current associated with the invention. The present invention advantageously reduces or completely eliminates the need for harsh thermal and/or catalytic conditions for necessary carbon rehybridization and fixation that are conducive to CNT and diamond formations. For diamond, the current invention provides high concentration of high spin carbon by magnetic densification via intense static magnetic fields of several teslas, thereby eliminating high-pressure requirements of older arts for diamond synthesis. Such lower thermal requirements result in lower production expenses. In addition, the present invention by IR and laser heating provides efficient excited carbon atoms for catalyzed intersystem crossing of excited electrons of carbon atoms, thereby eliminating high temperature collisional conditions for such high spin production in plasma techniques. Moreover, the use of intense magnetic field and simply changing the nature of the field allow insitu simultaneous or sequential formations of CNT and diamond within the same system. This invention discovers the use of magnetic energy for material synthesis, in particular the production of extremely important super-materials, such as the diamonds and CNTs. Furthermore, the present invention advantageously enhances the production rate and selective to levels commensurate with large-scale industrial use.

In an embodiment of the current invention, the heating provides a mechanism for increasing the kinetic energy of carbon and metal atoms. The resistance heating provides a controlled thermal atmosphere for CNT and diamond growth. The IR heating allows selective heating of the catalysts to higher temperatures for diamond and CNT formations. The CNT and diamond heating in lower ambient environment via the selective heating with IR radiation results in less poisoning of the catalyst, less defects in CNT, diamond and CNT formation under much lower temperatures. Geohegan and Liu have shown that laser heating and rapid heating history can reduce poisoning leading to longer tube growth.

In accordance with the current invention, carbonaceous articles are formed by contacting carbon-containing precursors and metal containing precursors with an intense magnetic field. The field may be static for diamond formation or dynamic for CNT formation. During the formation of the carbonaceous articles, a heating element is used to maintain the temperature of the atoms. Although the heating element is necessary it is important to note that in this invention the necessary temperature (<700° C.) is significantly less than the temperature in the older arts (i.e. Plasma T>3000° C. and CVD T>700° C.). Heating is also accomplished via laser and IR devices. During the formation of the carbonaceous articles, a metal catalyst (atoms, cluster, nanoparticles or bulk) may be supplied to facilitate the formation of the carbonaceous articles. During the formation of the carbonaceous articles, a laser may be used to rapidly heat the sample for causing the needed chemical decomposition, absorption, diffusion, rehybridization and condensation processes associated with CNT and diamond formations. The lasing may be synchronized with the magnetization of the catalyst and depositing carbon. The IR and laser heating and the magnetization causes, promotes, stabilizes and condenses triplett, quartet and pentet high spin states for more efficient CNT and diamond formations. During the formation of the carbonaceous articles, magnetic fields may be applied to the cavity in the reaction chamber to assist confinement of high spin carbon atoms within and about the catalyst. During the formation of carbonaceous articles the pressure is controlled so as to assist chemical condensation. Higher pressure favors diamond formation. In part the type of carbonaceous articles formed depends on the conditions of temperature; catalyst; pressure; IR energy; laser energy and intensity; magnetic field strength; and inverted carbon electronic states.

The diamond and CNT carbonaceous articles manufactured in accordance with the present invention can take the form of as fiber, fibril, filament, film, particles, bulk or solid.

The apparatus for the production of CNT and diamond carbonaceous articles of the present invention includes a reaction chamber having at least one heating element, catalysts, pressure regulating device, external lasers, and external magnetic field generator. In operation, carbon and metal containing precursors (hydrocarbon, metal compound and/or carbon-metal target) are introduced into the reaction chamber via precursors for CVD with the application of heat by laser and IR irradiations for electronic excitation and inversion of carbon atoms with an external magnetic field. Under these conditions, it is believed that the carbon and metal atoms atomize. It is believed that contacting the resulting carbon and metal atoms with the magnetic field and catalyst facilitates (under lower temperature CVD conditions) the electronic spin transitions of the electrons of excited carbon and metal atoms on the basis of efficient magnetic-spin interactions between the external field and interactions between the metal and carbon electrons for the enhanced fixation of the excited carbon via metal atoms for high spin carbon states that lead to condensation of CNT and diamonds. It is believed that the resulting triplett, quartet and pentet high spin carbon atoms from the intersystem crossing may be externally stabilized and stimulated by the external intense magnetic field under CVD conditions for greater probable high-spin, hybrid carbon states undergoing chemical condensation so as to selectively form CNT and diamond. It is believed that the external pressure and magnetic field confine the carbon and metal atoms within the catalysts in ways to allow chemical condensation of the carbonaceous articles.

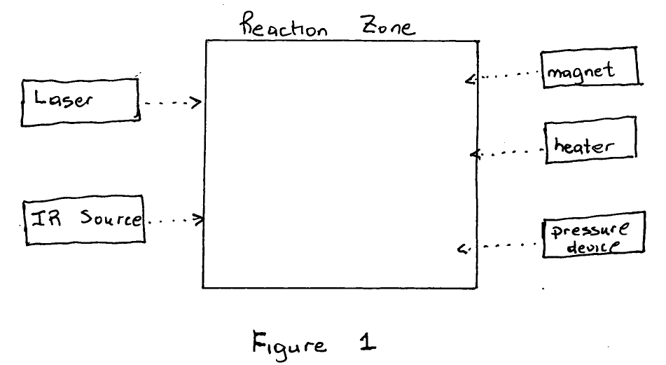

The inventive apparatus can take the physical form in a variety of parts and the arrangement of these parts. In FIG. 1, an apparatus according to the form of the current invention is illustrated. As shown in FIG. 1, the apparatus includes a reaction chamber and at laser one heat element, e.g. the combination of the reaction chamber and heating element may be commercially available. The reaction chamber may be equipped with resistance heater, IR heater and heating laser and inlet port for supplying carbon precursors, an outlet port and an encapsulating solenoidal magnet. The reaction chamber may be equipped with carbon gaseous precursors flowing to contact a catalyst as with CVD technology. The heating element and CVD may be of any design so long as it provides a sufficient thermal source of carbon and metal atoms. The reaction chamber includes at least one port for introducing the reactants and at least one port for exit of materials.

In the form of the present invention the reaction chamber is in the fluid communication with the carbon and metal sources within or without the reaction chamber or with flowing carbon and metal precursors supplied by inlet ports. The carbon and metal sources include but are not limited to CVD. In the form of the current invention, the carbon and metal atoms flow is controlled by CVD rate ect. . . . In practice, the carbon and metal precursors may be diluted with a background gases such as hydrogen, helium or argon or other reagent gases that are currently known to promote carbonaceous article formation.

In an embodiment of the current art, the reaction chamber provides a space/time for the decomposition of carbon precursors under the influence of the heating and catalyst particles in the magnetic environment; the electronic rehybridization of the resulting carbon atoms; the diffusion of carbon atoms; and the chemical condensation of the carbon atoms as diamonds and/or CNT. The heating and magnetization allow the atomized carbon and metals to be electronically excited, electronically spin polarized, electronically inverted about hybrid states, electronically confined by external fields and pressure for the driven chemical condensation of CNT and diamond carbonaceous articles under lower temperature and pressure conditions relative to older arts. The reaction chamber should be large enough to allow the internal laser heating. The reaction chamber should be shaped and sized so as to facilitate CVD under laser, IR and magnetization. The reaction chamber should be of such to allow heating and pressurizing so as to facilitate electronic processes and subsequent chemical condensation. The reaction chamber should be of the form for sufficient residence of carbon and metal atoms for efficient contact with the spin activating magnetic field and the heating laser and IR sources for the formation and stabilization of desirable triplett, quartet and pentet carbon states. The reaction chamber should facilitate the intervention of external magnetic fields so as to confine paramagnetic high spin carbon atoms within the reaction regions for chemical condensation of diamonds and CNTs.

The reaction chamber also includes at least one additional port, e.g. exit port for exhaust, flue gases or to attach a pressure device in fluid communication with the reaction chamber, e.g. vacuum pump to reduce pressure or to increase pressure.

In accordance with the current inventive apparatus, a catalyst or metal may be disposed to the reaction chamber in the form of transition metal precursor compound or as a seed element in the carbon targets. The catalyst may be metal atom, cluster nanoparticle or bulk particles that are freely dispersed or confined to a substrate.

In an embodiment of the present invention, the catalyst provides of necessary a basis for chemically catalyzing carbon rehybridization. The catalyst may be in the form of atoms, clusters, nanoparticle or macroparticles. The catalyst may be transition metal or transition metal compounds. The catalyst may be localized or substrate or uniformly disposed to the reaction zone. The temperature is fine tuned to maximize the influence of the catalyst. The magnetic field is fine tuned to maximize the influence of the catalyst. The laser heating is fine tuned to maximize the influence of the catalyst. The IR is fine tuned to maximize the influence of the catalyst.

In accordance with the current inventive apparatus at least one internal set-up may exist within the reaction chamber for laser irradiation for rapid heating. In the case of CVD source, at least one device may be present to laser irradiate the catalytic nanoparticles during their magnetization. An external laser may pump the carbon and metal atoms to create thermally assist production and stabilization of high spin electronic states of carbon for enhanced CNT and diamond synthesis. Any device capable of inverting the carbon and or metal atoms is suitable for the present inventive apparatus. The strength of the lasing should be so as to affect significant number of carbon atoms and possibly metal atoms on the substrate.

In accordance with the present inventive apparatus, at least one device or source of an IR is externally irradiating the substrate surface for selective heating of the metal catalysts. The IR is positioned outside the reaction chamber. Any device capable of the generation of a source of IR radiation can be used in the present inventive apparatus. The IR source may be continuous or pulsed also diffuse or focused. The energy of the IR is such to selectively affect the metal atoms so as to allow chemical, diffusional and electronic processes associated with CNT and diamond formations. In an embodiment of the current invention, the IR irradiation provides a mechanism selectively heating the metal instantaneously for decompositions, absorption, rehybridization and condensation of carbon. The IR pulse duration and or energy may be adjusted to compatibility with the confining magnetic field. The IR pulse duration and/or energy may be adjusted to optimize selective, massive chemical condensation of diamond and CNT or other carbonaceous articles. The IR flux, pulse duration and or energy may be adjusted to analyze, manipulate and control the selective mass chemical condensation of diamonds and CNTs.

In accordance with the present inventive apparatus, at least one device for generating magnetic field is placed near the reaction chamber. The device is placed external to the reaction chamber, attached on the outer surface or at a distance from the chamber. Any device capable of generating a magnetic field is suitable for this purpose.

In an embodiment of the present invention, the magnetic field provides a means for creating, stabilizing, controlling and condensing paramagnetic atoms in the reaction chamber for the confining the triplett, quartet, pentet, hexet, heptet carbon and metal species within the laser cavity. Various devices may generate the magnetic field. The magnetic field intensity, direction and duration may be so as to maximize confinement, population inversion and chemical condensation. The magnetic field intensity, duration and direction may be synchronized with IR irradiation so as to confine generate tripplett, quartet, pentet, hexet, heptet carbon and metal excited species. The magnetic field may be adjusted with regard to heat. The magnetic field may be adjusted with regard to pressure. The magnetic field may be adjusted with regard to heating laser. The magnetic field may be adjusted with regard to catalyst.

The inventive apparatus described by way of the above embodiment can be used to mass-produce carbonaceous articles, such as CNT and diamond for commercial, industrial and research applications. The various features and advantages of the present invention will become more apparent and facilitated by a description of its operation. As described above, the present inventive apparatus includes a chamber having a heating element, carbon and metal source, lasers, IR source, internal laser cavity, and an external magnetic field generator.

Carbon precursors suitable for use in the practice of the present invention are compounds containing carbon hydrogen; hydrocarbons may be oxygen-containing hydrocarbons, carbon oxides. Nonlimiting examples of such hydrocarbon compounds includes aromatic hydrocarbons, e.g. benzene, toluene . . . nonaromatic e.g. methane, ethane, . . . and oxygen containing e.g. alcohols, ketones and aldehydes. Carbon targets and electrodes, fullerenes and graphite targets.

Metal precursors suitable for use in the practice of the present invention are transition metals and compounds of transition metals. Also alloys of transition metals.

The catalyst need not by in active form before entry into the chamber so long as it can be readily activated under reaction conditions.

In practicing the present invention, carbonaceous articles are formed in the chamber by producing carbon and metal atoms from CVD and other sources. Heating the carbon and metal mixture provides some kinetic energy to facilitate events for subsequent chemical condensation. Modulating the pressure in the reaction chamber also facilitates collisional events for favorable chemical condensation. Interactions between carbon and metal atoms allow some rehybridization of carbon atoms for suitable chemical condensation. Contacting carbon atoms (and maybe metal atoms for indirect influence on carbon atoms) with an external magnetic field super-enhances the rehybridization of carbon atoms directly (via direct magnetization of carbon) and indirectly (via magnetization of metal and then metal carbon rehybridization). The magnetization and less so the metal rehybridization of carbon atoms result in triplett, quartet and pentet electronic states of carbon. The production of these high spin carbon states is synchronized with the magnetic confinement by external field. The magnetic field captures high spin atoms and confines within the reaction region. The laser heating assist populationally inverts high spin carbon atoms about important excited, high-spin, hybrid carbon states for diffusion, absorption and condensation for the selective chemical condensation of diamond, CNT and fullerenes.

Reaction parameters include to the particular precursors; catalyst; precursor temperature; catalyst temperature; reaction pressure; residence time; feed composition, including presence and concentration of any diluents (e.g. Ar) or compounds capable of reaction with carbon to produce gaseous products (e.g. CO, H₂ ,H₂ O); IR energy, spin polarity, flux and direction; laser pump energy; laser cavity; oscillator conditions; external magnetic field strength and direction. It is contemplated that the reaction parameters are highly interdependent and that the appropriate combination of the reaction parameters will depend on the precursor, catalyst, IR, laser cavity, heating, pressure and magnetic field for the article intended to be fabricated.

In practicing the present invention, the carbonaceous articles of CNT and diamond can be produced by providing a carbon and metal atom source; elevating the temperature to sufficient range tho less than in older art; contacting the carbon atoms and metal atoms at elevated temperature; controlling the pressure so as to select for CNT and diamond with fullerene at lowest pressure, then CNT slightly lower pressure and diamond at the highest pressures; irradiating the excited carbon atoms with IR of appropriate energy so as to facilitate electronic excitation; contacting the carbon with transition metals in the presence of static or dynamic magnetic fields for triplett, quartet and pentet carbon high spin formation, stabilization and condensation; laser heating the carbon and metal atoms; confining the high spin excited carbon atoms by using external magnetic fields so chemical condensation; levitating the growing carbonaceous articles in the magnetic field; changing process parameters T, concentration, electric field, magnetic field pressure, laser irradiation, IR irradiation, oscillation frequency so as to maximize specific carbon states and condensation of specific products i.e. CNT and diamond; and allowing these activities for an effective amount of time. By an effective amount of time it is meant for that amount of time needed to produce mass quantities. The amount of time may be from hours to days depending on conditions.

The carbon concentration should be high enough to allow the catalyst, IR, heat, laser energy, magnetic field and electric field and pressure to selectively condense CNT or diamond. The precise concentration will depend on the desired product.

The metal catalyst concentration should be high enough to allow the carbon, IR, heat, laser energy, magnetic field, and pressure to selectively condense CNT or diamond. The precise metal concentration will depend on the desired product. IR and lasing allow lower metal and possibly no metal for SWCNT.

The temperature should be high enough to allow the carbon catalyst, IR, laser energy, magnetic field, and pressure to selectively condense CNT or diamond. The precise temperature will depend on the desired product. The IR and laser may allow higher temperature without the need to use catalyst. Higher temperature and pressure may be bad due to collisional rehybridization. IR and laser may allow lower temperature collisions may not be factors because carbon is hard to rehybridize low density of states.

The laser heating should be at a wavelength that facilitates the rapid absorption and heating of the carbon and metal for efficient electronic, chemical, transport and condensation processes leading to diamond and CNT formation. The wavelength, intensity, pulse width and duration are process variables that are fine tuned to the desired product CNT and diamond.

The IR irradiation should be so as to facilitate the activation energy for electronic, chemical, transport and condensation of atoms to form triplett, quartet and pentet high spin states for chemical condensation of diamond and CNT. The selective heating of the metal catalyst by the IR allows the growth of diamond and CNT in lower temperature ambient environments. This growth in lower temperature ambient provides advantageous possibilities. The lower ambient temperature results in less thermal motion of CNT during growth, which leads to less tubular defects. The lower ambient temperature leads to greater alignment during growth in the magnetic field.

The pressure device should be in fluid communication with the reaction chamber and adjustable for high pressure to vacuum so as to facilitate.

The magnetic field is used to create, stabilize and concentrate high spin carbon and metal atoms. The magnetic field may separate high spin from low spin atoms, providing high density of high spin carbon for diamond nucleation and growth at pressures much less than older art.

It is contemplated that the chamber housing the carbon and metal atoms be maintained so that the heat pressure, exciting laser, IR, and magnetic field can influence these carbon and metal atoms. The heat (temperature) and pressure of the carbon and metal are maintained below a certain range so as to reduce collisional rehybridization of carbon atoms for selective diamond or CNT production.

In an embodiment of the present invention, CNT and/or diamond can be produced by passing carbon and metal through the apparatus having pressure, temperature, IR source, heating laser, and magnetic field. It is believed that by this process diamonds and CNT may grow (chemically condense) in the reaction zone.

The present apparatus allows the formation of CNT and diamond without much impurity. The much larger growth rate relative to older allows kinetically entrained doping of impurity. This new art produces high spin carbon at such high concentrations for rapid kinetically restricted chemical condensation and for possible controllable doping of diamond and CNT. The magnetic field suspends carbon actively as they grow.

In accordance with an embodiment of the present invention the final carbonaceous articles may be removed, separated from the metal.

### EXAMPLE

An apparatus was built by aligning the catalyst bed in a quartz tube within the furnace with a magnetic field source at National High Magnetic Field Laboratory. The catalyst was made by forming Fe/Mo nanoparticles from Fe/Mo cluster molecules. The Fe/Mo in the nanoparticles was roughly 1-2 nm. The catalyst was placed on a silicon substrate to form the catalyst bed. The catalyst bed was placed within the quartz tube having a length of 8 ft and diameter of 25 mm. The catalyst bed was arranged at a location of the quartz tube, where the tube wall was flattened (to form irradiation window) to facilitate the in-situ laser and IR irradiation of the interior. The quartz tube with the inserted catalyst bed was then located within the a specially designed furnace which contained two sets of diametrically aligned holes in the furnace walls at about halfway along its length. The hole pairs in the furnace walls define a line that intersect the axis of the tube furnace. The holes in the furnace allow irradiation and in-situ observation of the catalyst within the quartz tube as the furnace heats the quartz and catalyst for CNT and diamond formation. One hole pair is for IR irradiation. The other hole pair is for laser irradiation. The furnace was heated in the range of 600° C. to 1000° C. after the pressure in the tube was adjusted and a flowing atmosphere of Ar was established. After 10 minutes of Ar purging, Ar flow was stopped and hydrogen flow was started. After 10 minutes of purging with hydrogen, simultaneously CH₄ was introduced into the quartz tube and magnetic field from the superconducting magnet was directed onto the catalysts on the substrate. A laser beam and IR radiation were focused on the catalyst bed during the magnetization. For this particular example, the IRs and laser beams were focused on the catalyst during CVD. The IR are deep penetrating and permeate the catalytic NP affecting both the electrons of absorbed carbon atoms and the metal lattice. These IR, magnet-electron interactions enhance electronic spin transitions of carbon atoms that promote carbon diffusion through the catalyst and chemical precipitation as CNT and diamond. The laser in this example drives specific plasmons in the NP and phonons that facilitate carbon motion and electron interactions with neutrons for enhanced CNT and diamond formations.

Diamond and/or CNT were made by contacting methane with the catalyst while irradiating with magnetization and IR and laser photons. Subsequent characterization of the diamond and CNT revealed high purity and faster growth rate relative to the production in the absence of IR and laser irradiation.

The present invention provides enabling art for the fabrication diamond and CNT articles with improved yield, purity, selectivity and efficiency.

What is claimed:

1. A method and apparatus for producing carbon materials comprising the steps of laser and IR heating carbon and metal precursors, magnetization of the catalyst on the substrate during the heating for the excitation of carbon atoms to form important high spin hybrid carbon excited states for absorptive, diffusive, rehybridizing and condensing phenomena leading to the selective and massive stimulated chemical condensation of CNT and diamonds from these various inverted carbon intermediary high spin electronic states.
